(19) United States
(12) Patent Application Publication
(10) Pub. No.: US 2025/0117560 A1
(43) Pub. Date: Apr. 10, 2025

(54) METHOD AND APPARATUS FOR GENERATING A REAL NUMBER BASED CIRCUIT MODEL FOR SIMULATION

(71) Applicant: TEXAS INSTRUMENTS INCORPORATED, Dallas, TX (US)

(72) Inventors: Saksham Sangwan, Bengaluru (IN); Venkateswaran Padmanabhan, Bengaluru (IN); Guha Lakshmanan, Bengaluru (IN)

(21) Appl. No.: 18/481,711

(22) Filed: Oct. 5, 2023

(51) Int. Cl. G06F 30/367; G06F 111/10; G06N 3/063

(52) U.S. Cl. CPC G06F 30/367; G06N 3/063; G06F 2111/10

(57) ABSTRACT

A method comprises creating an electronic circuit design having a plurality of electronic components, creating an analog simulation model of the electronic circuit design, and executing the analog simulation model to generate one or more simulation logs representing simulated operation of the electronic circuit design. The method also comprises generating a neural network model based on the one or more simulation logs, the neural network model comprising a plurality of weights and generating a mathematical simulation model based on the neural network model.

### BACKGROUND

Modern circuit design often involves electronic design automation (EDA) tools to simulate and verify circuit operation and interconnections. Many EDA tools are specialized for analog circuits, for digital circuits, or for mixed-signal circuits, for example. Simulating the circuit design may be used to validate expected operational conditions of the circuit design. Developing a simulation model can include defining the circuit using a hardware description language (HDL), a hardware verification language (HVL), or a combination of the two.

Various metrics for evaluating different methods for converting the circuit design into a simulation model include simulation speed, simulation accuracy, model development efficiency (e.g., a measure of model development cycle time), and model verification efficiency (e.g., a measure of cycle time for verification of the development model). Circuit simulation model development based on one HDL versus development on another HDL reveals variances in the development metrics. For example, a first HDL (e.g., a Verilog-based HDL) targeted toward analog circuits may have low simulation speed, high simulation accuracy, low model development efficiency, and low model verification efficiency while a second HDL (e.g., a real-number-based HDL) targeted toward digital circuits may have high simulation speed, low simulation accuracy, medium model development efficiency, and medium model verification efficiency. It would be advantageous to have high values in all of these metrics without sacrificing in speed, accuracy, or efficiency.

### SUMMARY

In accordance with one aspect, a method comprises creating an electronic circuit design having a plurality of electronic components, creating an analog simulation model of the electronic circuit design, and executing the analog simulation model to generate one or more simulation logs representing simulated operation of the electronic circuit design. The method also comprises generating a neural network model based on the one or more simulation logs, the neural network model comprising a plurality of weights and generating a mathematical simulation model based on the neural network model.

In accordance with another aspect, an apparatus comprises one or more computer readable storage media and program instructions stored on the one or more computer readable storage media. The program instructions are executable by a processing system and direct the processing system to create an analog simulation model of an electronic circuit design and execute the analog simulation model to generate one or more simulation logs representing simulated operation of the electronic circuit design. The program instructions also direct the processing system to generate a neural network model based on the one or more simulation logs, the neural network model comprising a plurality of weights and generate a mathematical simulation model based on the neural network model.

### BRIEF DESCRIPTION OF THE DRAWINGS

In the drawings:

FIG. 1 is a block diagram of a process for generating a simulation model according to one or more disclosed implementations.

FIG. 2 is a flow diagram of the process of FIG. 1 according to one or more disclosed implementations.

FIG. 3 illustrates a VAMS hardware description language wrapper and I/O mapping block diagram according to one or more disclosed implementations.

FIG. 4 is a flow diagram illustrating a process for simulating a system incorporating an analog subsystem using a mathematical simulation model generated for the analog subsystem according to one or more disclosed implementations.

FIG. 5 is a block diagram of an example computer system that may be used to perform according to one or more disclosed implementations.

### DETAILED DESCRIPTION

In the following description, for purposes of explanation, numerous specific details are set forth in order to provide a thorough understanding of the examples disclosed herein. It will be apparent, however, to one skilled in the art that the disclosed example implementations may be practiced without these specific details. In other instances, structure and devices are shown in block diagram form in order to avoid obscuring the disclosed examples. Moreover, the language used in this disclosure has been principally selected for readability and instructional purposes and may not have been selected to delineate or circumscribe the inventive subject matter, resorting to the claims being necessary to determine such inventive subject matter. Reference in the specification to “one example” or to “an example” means that a particular feature, structure, or characteristic described in connection with the examples is included in at least one implementation.

As used herein, the term “medium” refers to one or more non-transitory physical media that together store the contents described as being stored thereon. Examples may include non-volatile secondary storage, read-only memory (ROM), and/or random-access memory (RAM).

As used herein, the term “application” refers to one or more computing modules, programs, processes, workloads, threads and/or a set of computing instructions executed by a computing system. Example implementations of applications and functions include software modules, software objects, software instances and/or other types of executable code.

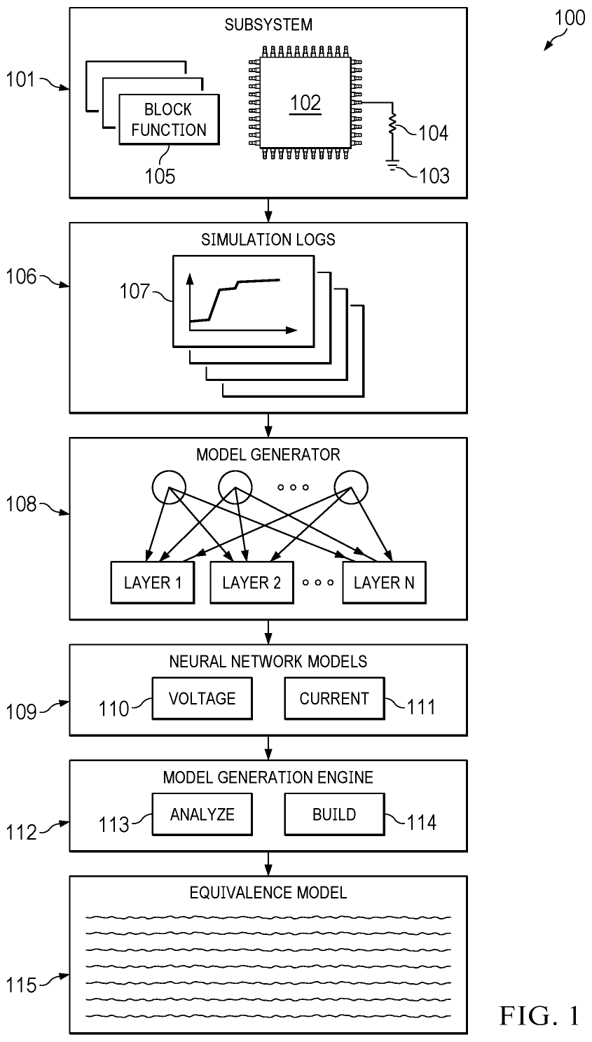

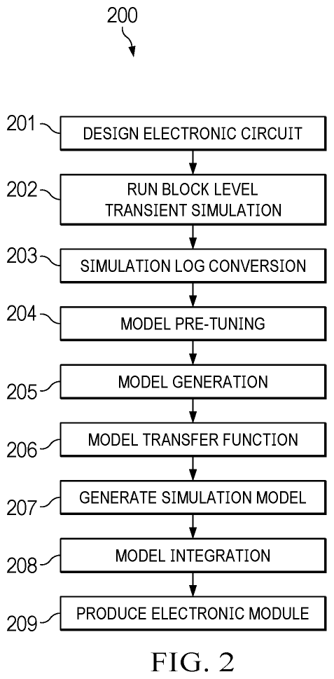

FIG. 1 is a block diagram of a process 100 for generating a simulation model according to an embodiment. A flow diagram 200 of the process 100 is illustrated in FIG. 2 according to an embodiment. Referring to FIGS. 1 and 2, an electronic circuit (e.g., subsystem) 101 is designed at block 201. The electronic circuit 101 may be based on product design specifications provided to a supplier by a third party that desires the supplier to develop and produce a new product or an improved product, for example. Alternatively, the electronic circuit 101 may be a new design desired by the supplier to showcase a new product for sale to potential customers. The electronic circuit 101 may be electronically designed within an electronic circuit design environment or may be physically designed at a design workstation. FIG. 1 illustrates an electronic component 102 such as an application-specific integrated circuit (ASIC) or other type of processor having an input or output line coupled to ground 103 via a resistor 104 in the simplified block diagram design. In some examples, electronic component 102 includes an analog circuit and/or a mixed-signal circuit. However, the electronic circuit 101 itself will typically be more complex, and the block diagram symbols illustrated in FIG. 1 are merely a representation of the more complex circuit under design. The electronic circuit 101 operates under one or more block functions 105, each block function 105 configured to simulate operation related to one or more functionalities such as power up, power down, functional coverage, and the like.

The designed electronic circuit 101 may undergo analog simulation 106 at block 202. In one embodiment, the simulation is performed via a simulation package compatible with the SPICE (Simulation Program with Integrated Circuit Emphasis) simulation language. The simulation 106 can be used to provide simulation logs 107 illustrating simulated operation of the electronic circuit 101 under one or more operational scenarios. For example, a block level transient simulation may be run to test one or more of the block functions 105. The simulation logs 107 provide simulated operational data based on the block functions 105 for verification and validation if desired. Use of the analog simulation 106 during a design process for running multiple simulations of the electronic circuit 101 (e.g., in SPICE) may achieve high accuracy but may be slower than digital implementations such as using a real number model. In addition, modifying and regenerating the analog simulation 106 may be slower than modifying and generating a digital simulation file (e.g., the mathematical simulation model 115). A review of the simulation logs 107 that indicates an undesirable operational characteristic of the electronic circuit 101 may lead to a modification of the electronic circuit 101 and a subsequent simulation to produce an approved version of the subsystem 101. At block 203, the simulation logs 107 are converted in preparation for data pre-processing. A conversion tool converts the simulation logs 107 to a comma-separated values (CSV) file format, for example.

Model pre-tuning is performed at block 204 where values are assigned to a plurality of conversion settings. Example algorithm conversion settings include the network type, the number of layers, the accuracy, and the activation function. Model pre-tuning further includes input/output (I/O) mapping of the inputs and outputs. Based on inputs as features, testcase data as a training set, and the assigned values, a model generator 108 generates a neural network model 109 at block 205. The neural network model 109 can include a voltage model 110 and a current model 111 having a plurality of weights and bias values.

A model generation engine 112 extracts and analyzes 113 the weights and bias values from the neural network model 109, and a machine-learning-based model transfer function is built 114 with the values extracted at block 206. Additional example details of using machine learning in EDA applications can be found in commonly assigned U.S. patent application Ser. No. 17/846, 181, entitled “Machine Learning Techniques for Circuit Design Debugging,” filed Jun. 22, 2022, which is incorporated by reference in its entirety. A mathematical simulation model 115 is generated at block 207 by integrating a digital-simulation-based kernel with the transfer function. The digital-simulation-based kernel may be a kernel compatible with a hardware description and hardware verification language (e.g., such as System Verilog). The transfer function includes a plurality of mathematical equations, each mathematical equation representing a behavior of a respective simulation log 107. In one embodiment, the mathematical simulation model 115 is a digital equivalence model that is a real number model of the analog electronic circuit 101.

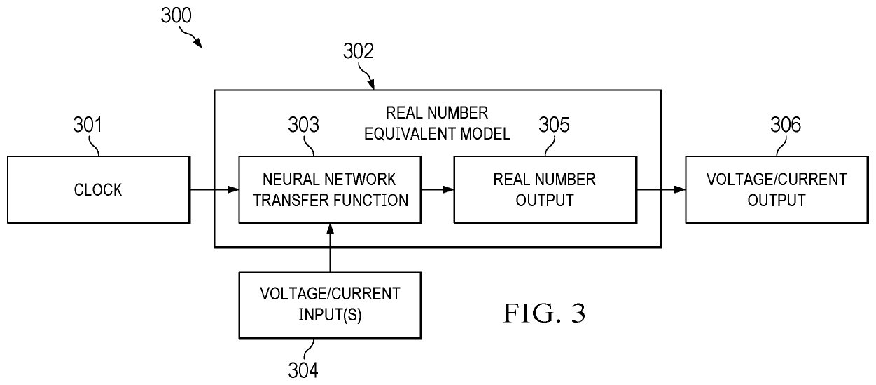

Integration of the mathematical simulation model 115 at block 208 can include integration of a Verilog analog and mixed-signal (VAMS) hardware description language wrapper and I/O mapping that assigns pin type based on pin behavior (e.g. current behavior or voltage behavior). A VAMS hardware description language wrapper and I/O mapping block diagram 300 is illustrated in FIG. 3 according to an embodiment. At block function 301, a free running clock is instantiated to provide triggers at every clock edge (rising and falling). The frequency of the clock may be based on simulation time steps or on another parameter. The clock signal is used by real number equivalent model 302 to generate transient response using transfer function that takes inputs and generates real number output. A neural network transfer function block 303 that computes an output at each clock edge trigger. One or more voltage and/or current inputs of block 304 are input into the neural network transfer function block 303 for the generation of a real number output at block 305. A voltage and/or current output at block 306 is generated based on the real number output 305.

Returning to FIG. 2, configuration selection can include setting the view for models in configuration of the testbench, and a SPICE simulation is run. Based on the validation, the designer can manufacture the approved electronic circuit 101 by forming a pattern of the electronic circuit design on a semiconductor wafer to produce the designed electronic circuit in physical form at block 209. In some examples, the designer or a foundry at the direction of the designer can create (e.g., by etching and/or patterning) the approved electronic circuit 101 onto the semiconductor wafer using the mathematical simulation model 115. The designed electronic circuit may include an analog circuit, a digital circuit, and/or a mixed-signal circuit that is fabricated based on the approved design. For example, the designer can fabricate the approved electronic circuit 101 based on the mathematical simulation model 115.

In accordance with the techniques of this disclosure, a process for designing a circuit may include creating an initial circuit design that includes an analog block. The process may further include configuring a design language model of the analog block using a neural network. In addition, the process may include running a simulation suing the design language model of the analog block. The process may also include adjusting the initial circuit design based on the simulation. For example, the simulation may indicate one or more points to improve the design, which can be used to adjust the initial circuit design. Finally, the process may include forming a pattern of the circuit design on a semiconductor wafer. In some examples, the design and fabrication steps may be performed by separate actors (i.e., a design company and a foundry).

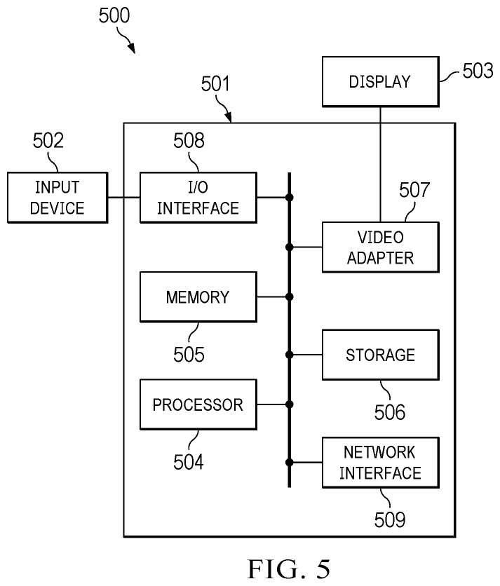

This process may be performed by the computer system described with respect to FIG. 5 described below.

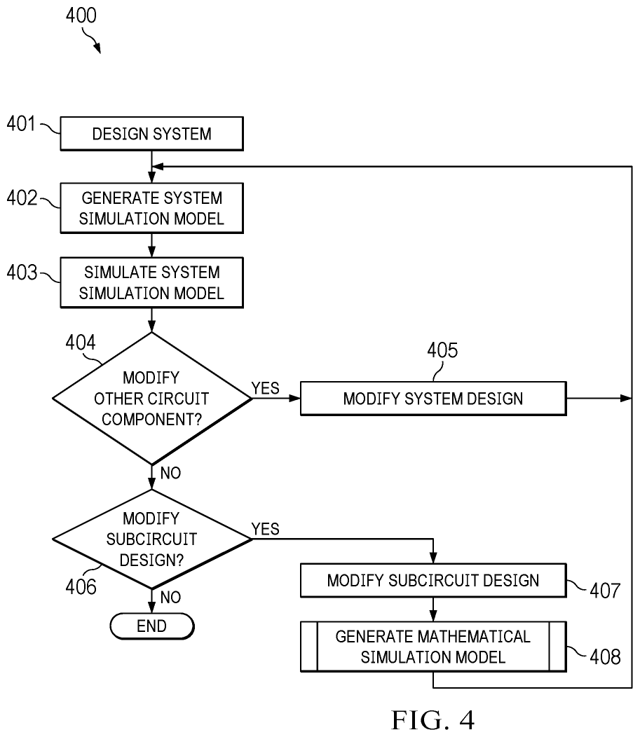

FIG. 4 illustrates a process 400 for simulating a system incorporating a subsystem component such as the electronic circuit 101 of FIG. 1. As described herein, the mathematical simulation model 115 is generated for the electronic circuit 101 that allows for increased simulation speed with high accuracy. Once generated, the mathematical simulation model 115 can be used during simulation of a system that includes the electronic circuit 101. At block 401, an analog system is designed that incorporates the analog electronic circuit 101 as a subsystem. A simulation model is generated at block 402 for the designed analog system. Generation of the simulation model includes using the mathematical simulation model 115 for the analog subsystem 101 in the system simulation model. A simulation of the system is performed at block 403.

Based on the results of the system simulation, a designer can choose, at block 404, whether system modification is desired for a component in the system other than the electronic circuit 101. If so, the design of the other component at block 405 can be modified. After modifying the design of the other component, the designer can re-generate the simulation model and run a second simulation for the system at blocks 402-403. Based on the results of the second system simulation, a designer can modify the design of another component in the system other than the electronic circuit 101. The mathematical simulation model 115 allows for multiple system simulations without the latency of using an analog simulation file for the electronic circuit in the system simulations. In some examples, the designer can run repeated system simulations using the same mathematical simulation model 115, avoiding the latency of regenerating a new analog simulation 106 and a new mathematical simulation model 115. Thus, by generating the mathematical simulation model 115 based on the analog simulation 106, the design process can leverage the accuracy of the analog simulation 106 and the speed of the mathematical simulation model 115, while avoiding the slowness of using only the analog simulation 106.

After a system simulation (e.g., such as in block 403), the designer can choose, at block 406, to modify the design for the subcircuit (e.g., the electronic circuit 101). If the subcircuit 101 is to be modified, the analog portion of the electronic circuit 101 is modified at block 407. At block 408, a new mathematical simulation model for the modified electronic circuit 101 is generated by, for example, executing blocks 202-208 as described herein. Then, the designer can use the revised mathematical simulation model 115 in the next system simulation by returning to block 402 and incorporating the revised mathematical simulation model 115 in the system model generation. In some examples, the designer may generate the new mathematical simulation model 115 at block 408 by skipping one or more steps in the model generation process of FIG. 2 that generate a new analog simulation 106, thus avoiding the latency of generating a new analog simulation 106.

The system simulation process 400 ends at block 409 after circuit modification is completed.

FIG. 5 is a block diagram of an example computer system 500 that may be used to perform electronic circuit design simulation as described herein. For example, the computer system 500 may be used to perform one or more of blocks 202-208 of the operation 200 illustrated in FIG. 2. The computer system 500 includes a processing unit 501 coupled to one or more input devices 502 (e.g., a mouse, a keyboard, or the like), and one or more output devices, such as a display screen 503. The display screen 503 may be used to display progress of the simulation described herein to allow a user to monitor the operational performance of the simulation. In some embodiments, the display screen 503 may be touch screen, thus allowing the display screen 503 to also function as an input device. The processing unit 501 may be, for example, a desktop computer, a workstation, a laptop computer, a tablet, a dedicated unit customized for a particular application, a server, or the like. The display screen 503 may be any suitable visual display unit such as, for example, a computer monitor, an LED, LCD, or plasma display, a television, a high-definition television, or a combination thereof. The display screen 503 can be used, for example, to perform and display the simulation and display the performance status of the simulation such as that described herein.

The processing unit 501 includes a processor 504, memory 505, a storage device 506, a video adapter 507, and an I/O interface 508 connected by a bus. The bus may be one or more of any type of several bus architectures including a memory bus or memory controller, a peripheral bus, video bus, or the like. The processor 504 may be any type of electronic data processor. For example, the processor 504 may be a processor from Intel Corp., a processor from Advanced Micro Devices, Inc., a Reduced Instruction Set Computer (RISC), an Application-Specific Integrated Circuit (ASIC), or the like. The memory 505, e.g., a non-transitory computer-readable medium, can be any type of system memory such as static random-access memory (SRAM), dynamic random-access memory (DRAM), synchronous DRAM (SDRAM), read-only memory (ROM), a combination thereof, or the like. Further, the memory 505 can include ROM for use at boot-up, and DRAM for data storage for use while executing programs.

The storage device 506, e.g., a non-transitory computer-readable medium, can include any type of storage device configured to store data, programs, and other information and to make the data, programs, and other information accessible via the bus. In one or more embodiments, the storage device 506 stores software instructions to be executed by the processor 504 to perform embodiments of the methods described herein. The storage device 506 may be, for example, one or more of a hard disk drive, a magnetic disk drive, an optical disk drive, a solid-state drive, or the like.

The video adapter 507 and the I/O interface 508 provide interfaces to couple external input and output devices to the processing unit 501. The processing unit 501 also includes a network interface 509. The network interface 509 allows the processing unit 501 to communicate with remote units via a network (not shown). The network interface 509 may provide an interface for a wired link, such as an Ethernet cable or the like, or a wireless link. The computer system 500 may also include other components not specifically shown. For example, the computer system 500 may include power supplies, cables, a motherboard, removable storage media, cases, and the like.

This disclosure has attributed functionality to the processing unit 501 and processor 504. The processing unit 501 and processor 504 may include one or more processors. Processing unit 501 and processor 504 may include any combination of integrated circuitry, discrete logic circuitry, analog circuitry, such as one or more microprocessors, microcontrollers, digital signal processors, application specific integrated circuits, central processing units, graphics processing units, field-programmable gate arrays, and/or any other processing resources. In some examples, processing unit 501 and processor 504 may include multiple components, such as any combination of the processing resources listed above, as well as other discrete or integrated logic circuitry, and/or analog circuitry.

The techniques described in this disclosure may also be embodied or encoded in an article of manufacture including a non-transitory computer-readable storage medium, such as memory 505 and storage 506. Example non-transitory computer-readable storage media may include RAM, ROM, programmable ROM, erasable programmable ROM, electronically erasable programmable ROM, flash memory, a solid-state drive, a hard disk, magnetic media, optical media, or any other computer readable storage devices or tangible computer readable media. The term “non-transitory” may indicate that the storage medium is not embodied in a carrier wave or a propagated signal. In certain examples, a non-transitory storage medium may store data that can, over time, change (e.g., in RAM or cache).

Benefits of the embodiments described herein provide machine-learning-based real number model generation that ensures that its behavior is matching an expected/ideal analog simulation model whose function (e.g., from the simulation logs) has been analyzed to create the real number model. The creation of the real number model based on machine learning reduces or eliminates some of the errors and analysis that a manually created behavioral model can include. Further, the amount of effort needed to use the manually created behavioral model is greatly reduced as well. Once the real number model is developed, it can replace its analog simulation model equivalent in new simulation runs of the same or other circuits incorporating the modelled circuit because of the benefit that it provides by improving the overall simulation speed.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. A method comprising:
creating an electronic circuit design having a plurality of electronic components;
creating an analog simulation model of the electronic circuit design;
executing the analog simulation model to generate one or more simulation logs representing simulated operation of the electronic circuit design;
generating a neural network model based on the one or more simulation logs, the neural network model comprising a plurality of weights; and
generating a mathematical simulation model based on the neural network model.

2. The method of claim 1, wherein the analog simulation model comprises one or more blocks, each block configured to simulation operation related to one or more functionalities; and
wherein executing the analog simulation model comprises generating a simulation log for each functionality.

3. The method of claim 2, further comprising converting each simulation log into a comma-separated values file format.

4. The method of claim 2, further comprising assigning values to a plurality of conversion settings.

5. The method of claim 4, wherein generating the neural network model comprises generating the neural network model further based on the plurality of conversion settings.

6. The method of claim 5, wherein generating the mathematical simulation model comprises building a transfer function based on the plurality of weights.

7. The method of claim 6, wherein generating the mathematical simulation model further comprises integrating a digital-simulation-based kernel with the transfer function.

8. The method of claim 7, further comprising mapping pins in the mathematical simulation model based on a behavior of the pins.

9. The method of claim 8, wherein the behavior of the pins comprises one of a current behavior and a voltage behavior.

10. The method of claim 6, wherein the transfer function comprises a plurality of mathematical equations, each mathematical equation representing a behavior of a respective simulation log.

11. The method of claim 1, wherein the mathematical simulation model comprises a real number model.

12. The method of claim 1, further comprising:
forming a pattern of the electronic circuit design on a semiconductor wafer based on the electronic circuit design.

13. An apparatus comprising:
one or more computer readable storage media;
program instructions stored on the one or more computer readable storage media, the program instructions executable by a processing system to direct the processing system to:
create an analog simulation model of an electronic circuit design;
execute the analog simulation model to generate one or more simulation logs representing simulated operation of the electronic circuit design;
generate a neural network model based on the one or more simulation logs, the neural network model comprising a plurality of weights; and
generate a mathematical simulation model based on the neural network model.

14. The apparatus of claim 13, wherein the analog simulation model comprises one or more blocks, each block configured to simulation operation related to one or more functionalities; and
wherein executing the analog simulation model comprises generating a simulation log for each functionality.

15. The apparatus of claim 14, wherein the program instructions further direct the processing system to:
assign values to a plurality of conversion settings.

16. The apparatus of claim 15, wherein the program instructions further direct the processing system to:
build a transfer function based on the plurality of weights.

17. The apparatus of claim 16, wherein the program instructions further direct the processing system to:
integrating a digital-simulation-based kernel with the transfer function.

18. The apparatus of claim 17, wherein the program instructions further direct the processing system to:
map pins in the mathematical simulation model based on a behavior of the pins.

19. The apparatus of claim 15, wherein the transfer function comprises a plurality of mathematical equations, each mathematical equation representing a behavior of a respective simulation log.

20. The apparatus of claim 13, wherein the mathematical simulation model comprises a real number model.
